(19) United States
(12) Patent Application Publication
(10) Pub. No.: US 2024/0289822 A1
(43) Pub. Date: Aug. 29, 2024

(54) METHODS, SYSTEMS, ARTICLES OF MANUFACTURE, AND APPARATUS TO DETERMINE PRODUCT IMPORTANCE

(71) Applicant: Nielsen Consumer LLC, Chicago, IL (US)

(72) Inventors: Dinesh Neelendra Mehta, Vernon Hills, IL (US); Alvin Lim, Turtletown, TN (US)

(21) Appl. No.: 18/176,353

(22) Filed: Feb. 28, 2023

(51) Int. Cl. G06Q 30/0202; G06Q 30/0201

(52) U.S. Cl. CPC G06Q 30/0202; G06Q 30/0206

(57) ABSTRACT

Methods, apparatus, systems, and articles of manufacture are disclosed to determine product importance identify transactional attributes associated with a product of interest, apply a machine learning model to generate a coefficient for respective ones of the transactional attributes associated with the product of interest, generate an importance probability corresponding to the product of interest based on the coefficient for respective ones of the transactional attributes and a frequency of the respective ones of the transactional attributes, generate a binary importance metric based on the importance probability and a threshold value, generate an indication for the importance probability and the binary importance metric of the product of interest based on the coefficient for respective ones of the transactional attributes and the frequency of the respective ones of the transactional attributes, and cause a trigger response based on the indication corresponding to the product of interest.

### FIELD OF THE DISCLOSURE

This disclosure relates generally to marketing analysis and, more particularly, to methods, systems, articles of manufacture, and apparatus to determine product importance.

### BACKGROUND

In recent years, market participants (e.g., retailers, manufacturers, service providers, etc.) manage many thousands of products in an effort to determine their performance in different markets. Because identifying product metrics requires financial and/or effort investments, the market participants have an interest to improving the techniques associated with product metric research.

### BRIEF DESCRIPTION OF THE DRAWINGS

FIG. 1 is a schematic illustration of an example environment to determine product importance constructed in accordance with teachings of this disclosure.

FIG. 2 is a block diagram of example product importance circuitry to facilitate the example environment of FIG. 1 in accordance with teachings of this disclosure.

FIG. 3 is an illustration of example ranking to facilitate the example environment of FIG. 1.

FIGS. 4 and 5 are flowcharts representative of example machine readable instructions and/or example operations that may be executed by example processor circuitry to implement the example product importance circuitry of FIGS. 1 and 2.

FIG. 6 is a block diagram of an example processing platform including processor circuitry structured to execute the example machine readable instructions and/or the example operations of FIGS. 4 and 5 to implement the example product importance circuitry of FIGS. 1 and 2.

FIG. 7 is a block diagram of an example implementation of the processor circuitry of FIG. 6.

FIG. 8 is a block diagram of another example implementation of the processor circuitry of FIG. 6.

FIG. 9 is a block diagram of an example software distribution platform (e.g., one or more servers) to distribute software (e.g., software corresponding to the example machine readable instructions of FIGS. 4 and 5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

To determine the likelihood that a product is important or unimportant and why, market participants rely on expert opinion, use their own discretion, or other computational resources. For instance, a typical grocery store in North America carries about 50,000 products. From a market participant's (e.g., a manufacturer of a product, a retailer, etc.) perspective, products that generate a significant amount of revenue and have a high number of transactions may be important, but products with a high number of substitutes may be unimportant. A first geographic region may consider a specific ethnic food product as important due to a threshold sales volume, while a second geographic region may consider that particular ethic food product as unimportant because the sales volume is substantially less when compared to the first geographic region. In some examples, demographic differences between a first geographic region and a second geographic region help to explain why particular products exhibit different sales metrics. A single indication or characteristic on why a product is important or unimportant is also not clear because several factors such as revenue product price, number of transactions, etc. may contribute to the product importance.

The computational resources involved to determine the likelihood that a product is important or unimportant and why is not only complicated and computationally expensive to implement and automate, but also leads to inaccurate product importance determinations. Such inaccurate determinations lead to erroneous market effects (e.g., producing too much of an unimportant product, attempting to sell a particular product in a particular geographic region, etc.) and indications for product being important or unimportant.

Unlike traditional approaches of determining product importance, which represent ad hoc or computationally expensive processes, examples disclosed herein structure the product importance determination process to, in part, determine if the product is important or unimportant, determine the likelihood that a product is important or unimportant, and determine an indication corresponding to the product importance. In other words, examples disclosed herein generate a trained model that initially utilizes expert opinion on a set of products to determine and analyze product importance for an alternate product. Thus, examples disclosed herein eliminate market participants' reliance on discretionary guesses by retailers to decide, for instance, which products to stock, which products to remove from shelves, and/or which products to promote. Additionally, examples disclosed herein reduce computationally expensive processes to troubleshoot which prior stocking and/or promotional decisions were unsuccessful. For instance, in the event a retailer (e.g., a manager chartered with the responsibility to stock particular products, promote particular products, determine how to display particular products on shelves, etc.) makes product selection decisions at a first time, aggregate sales metrics may exhibit undesirable drops. Because the retailer likely made many such decisions of which products to stock and/or promote, computational efforts to calculate which ones of those decisions was the cause increases. Furthermore, there are thousands of products at a single retail store and the human mind is uncapable to process, in a reasonable amount of time, the importance of a product in a fast-moving market. Each product may have dozens of transactional attributes (e.g., revenue, number of transactions, price, etc.) which are relevant to determining how important a product is and the determination of a product's importance would be impractical to calculate by a human mind as the market constantly changes. Accordingly, examples disclosed herein reduce a need for such computational efforts to identify the poorly performing products that were selected and/or otherwise promoted based on a discretionary choice by the retailer.

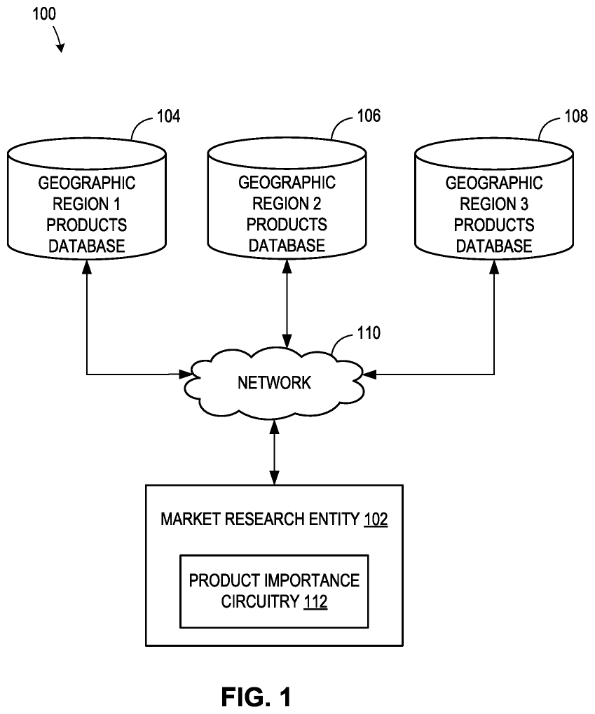

FIG. 1 is a schematic illustration of an example environment 100 to determine product importance constructed in accordance with teachings of this disclosure. In the illustrated example of FIG. 1, the environment 100 includes an example market research entity (MRE) 102 communicatively connected to an example network 110. For instance, the example MRE 102 of FIG. 1 is communicatively connected to an example network 110 that is further communicatively connected to an example first geographic region products database 104, an example second geographic region products database 106, and an example third geographic region products database 108. While the illustrated example of FIG. 1 includes the aforementioned databases (e.g., data sources), examples disclosed herein are not limited thereto. In some examples, the aforementioned databases and/or data from such databases may be aggregated into a single or multiple databases which are either communicatively connected to the MRE 102 via the example network 110, and/or directly communicatively connected to the MRE 102. As described in further detail below, the MRE 102 includes example product importance circuitry 112 to determine product importance as explained with a use case scenario of determining product importance for marketing analysis. While examples disclosed herein consider a use case scenario of determining product importance for marketing analysis, such examples disclosed herein are not limited to that use case scenario.

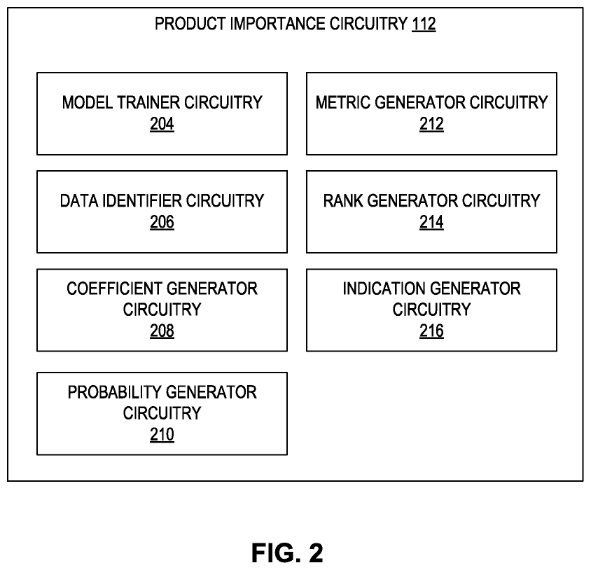

FIG. 2 illustrates additional detail corresponding to the example product importance circuitry 112 of FIG. 1. In the illustrated example of FIG. 2, the example product importance circuitry 112 includes example model trainer circuitry 204, example data identifier circuitry 206, example coefficient generator circuitry 208, example probability generator circuitry 210, example metric generator circuitry 212, example rank generator circuitry 214, and example indication generator circuitry 216.

In operation, and as described in further detail below, the example model trainer circuitry 204 trains a product importance model. The example data identifier circuitry 206 identifies input product data such as a product and corresponding attributes (e.g., revenue, number of transactions, number of substitutes, price, etc.). The example coefficient generator circuitry 208 determines one or more coefficients from a logistic regression model for each attribute, and the example probability generator circuitry 210 generates an importance probability (e.g., the likelihood that a product is important or unimportant) using one or more coefficients and attribute frequency. The example metric generator circuitry 212 generates an importance metric (e.g., whether a product is important or unimportant), and the example rank generator circuitry 214 generates a rank for each product using the importance probability. The example indication generator circuitry 216 generates an indication of why a product is likely important or unimportant using the coefficient associated with each attribute and the attribute frequency.

As described above, the illustrated example of FIG. 2 is a block diagram of the example product importance circuitry 112 to determine product importance. The example product importance circuitry 112 of FIGS. 1 and 2 may be instantiated (e.g., creating an instance of, bring into being for any length of time, materialize, implement, etc.) by processor circuitry such as a central processing unit executing instructions. Additionally or alternatively, the example product importance circuitry 112 of FIGS. 1 and 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIGS. 1 and 2 may be implemented by microprocessor circuitry executing instructions to implement one or more virtual machines and/or containers.

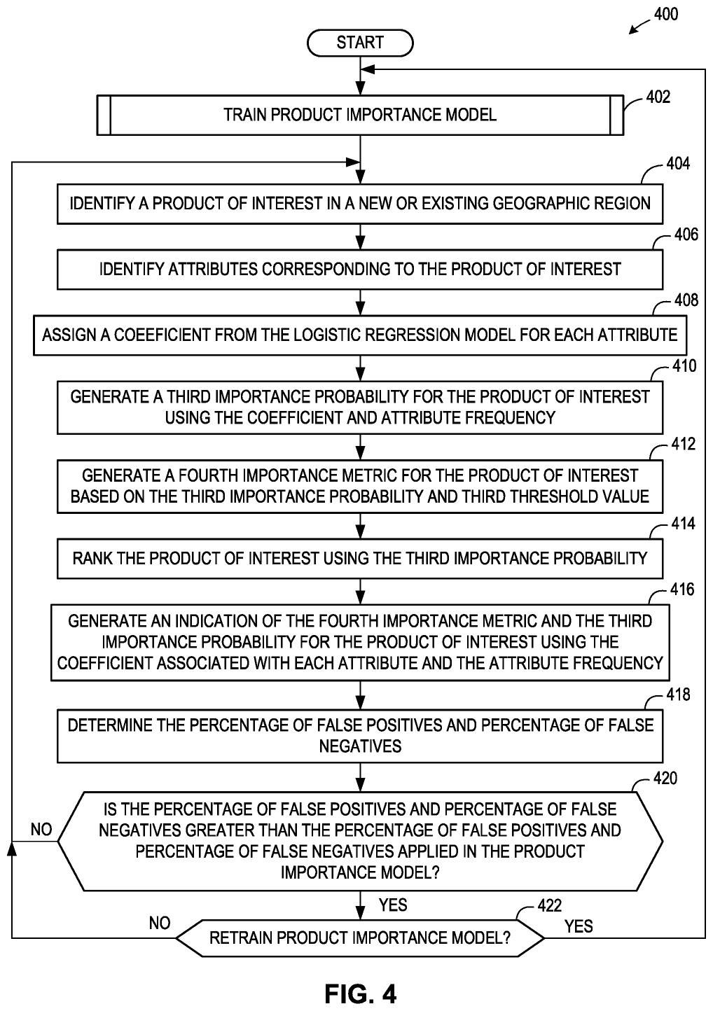

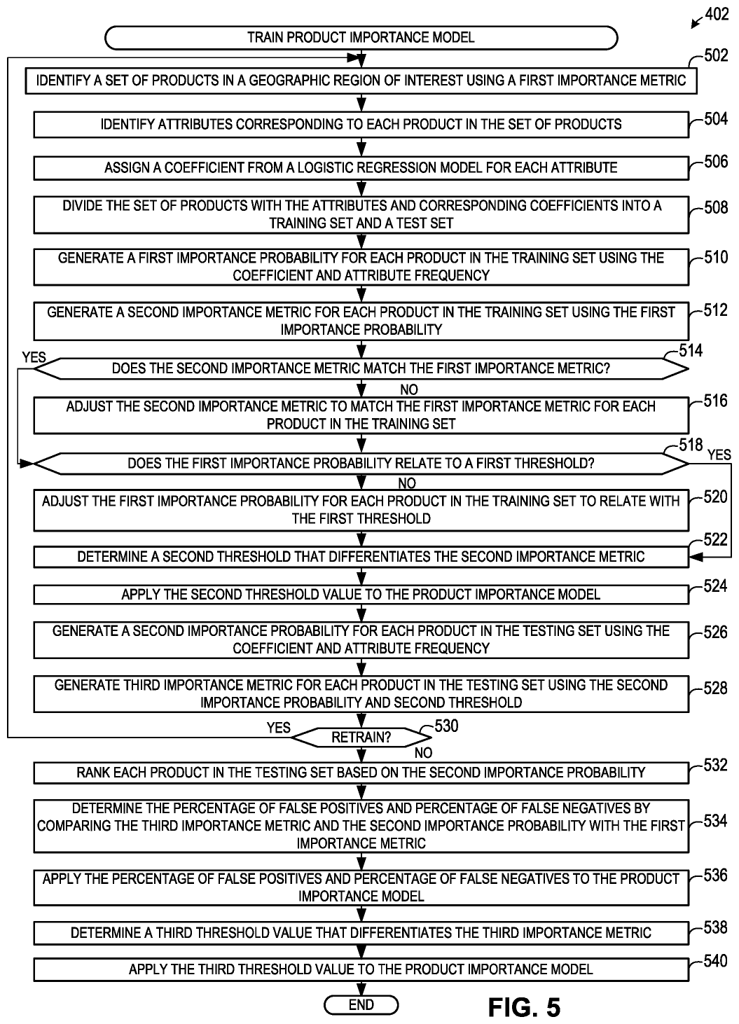

In some examples, the example model trainer circuitry 204 is instantiated by processor circuitry executing model trainer instructions and/or configured to perform operations such as those represented by the flowcharts of FIGS. 4 and 5. In some examples, the example data identifier circuitry 206 is instantiated by processor circuitry executing data identifier instructions and/or configured to perform operations such as those represented by the flowcharts of FIGS. 4 and 5. In some examples, the example coefficient generator circuitry 208 is instantiated by processor circuitry executing coefficient generator instructions and/or configured to perform operations such as those represented by the flowcharts of FIGS. 4 and 5. In some examples, the example probability generator circuitry 210 is instantiated by processor circuitry executing probability generator instructions and/or configured to perform operations such as those represented by the flowcharts of FIGS. 4 and 5. In some examples, the example metric generator circuitry 212 is instantiated by processor circuitry executing metric generator instructions and/or configured to perform operations such as those represented by the flowcharts of FIGS. 4 and 5. In some examples, the example rank generator circuitry 214 is instantiated by processor circuitry executing rank generator instructions and/or configured to perform operations such as those represented by the flowcharts of FIGS. 4 and 5. In some examples, the example indication generator circuitry 216 is instantiated by processor circuitry executing indication generator instructions and/or configured to perform operations such as those represented by the flowcharts of FIGS. 4 and 5.

Returning to the illustrated example of FIG. 2, in operation the example model trainer circuitry 204 trains the product importance model. The product importance model is a data structure containing trained coefficient values. This data structure could be stored in, for instance, the product importance circuitry or a memory thereof. There are thousands of products located around the globe. Each geographic region (e.g., Northeast, Illinois, Southwest, etc.) may have different effects on a product being important or unimportant. For instance, a particular ethnic food may be important in Texas but not in Tennessee. To train the product importance model, the example model trainer circuitry 204 identifies a set of products (e.g., milk, bread, chips, tissues, etc.) in a first geographic region of interest. In some examples, set of products includes at least ten important products and at least ten unimportant products, with an equal number of important products and unimportant products. However, examples disclosed herein are not limited thereto. The consideration of each product in the set of products being important or unimportant is made by an expert, which is an initial discretionary aspect of examples disclosed herein. The consideration of each product in the set of products being important or unimportant is also known as a first importance metric. As used herein, a first importance metric is a binary metric that represents each product in the set of products being important or unimportant.

After the set of products in a geographic region is identified, the example model trainer circuitry 204 identifies attributes (e.g., revenue, number of transactions, number of substitutes, price, etc.) for each product in the set of products. An attribute is a transactional characteristic associated with a product such as the previously mentioned examples. For instance, a product (milk) of the set of products (milk, bread, chips, tissues, etc.) may have a first importance metric deemed or otherwise important and include attributes such as annual revenue (e.g., $125,000), number of substitutes (0), and number of transactions per year (50,000). Substitutes for a product represent alternative products that can replace a product. The higher the number of substitutes, the less important a product may be. In previous example, a high annual revenue, a low number of substitutes, and a high number of annual transactions may be indicative of an important product.

After attributes corresponding to each product in the set of products are identified by the example model trainer circuitry 204, a coefficient from a logistic regression model is arbitrarily assigned to each attribute. A coefficient is a value greater than or equal to 0 that is assigned to an attribute. In other words, the higher the coefficient value, the more significant the attribute is. In some examples, the coefficient is generated from a logistic regression model. Using the previous example above with milk having attributes including annual revenue (e.g., $125,000), number of substitutes (0), and number of transactions per year (50,000), the attribute of annual revenue may be assigned a coefficient of 0.5, the attribute of number of substitutes may be assigned a coefficient of 0.3, and the attribute of number of transactions per year may be assigned a coefficient of 0.1. A significance of an attribute or the importance an attribute is determined by the resultant mathematical product of a frequency of an attribute and its coefficient. A frequency of an attribute is the value corresponding to a number of instances or occurrences of the attribute. For example, if the resultant mathematical products of the frequency of an attribute and its coefficient for annual revenue, number of substitutes, and number of transactions were $75,000, 0, and 5,000, respectively, annual revenue would be the most significant attribute while number of substitutes would be the least significant attribute. The significance of an attribute is important in determining how important a product may be. Initially to train the product importance model, the example model trainer circuitry 204 arbitrarily assigns coefficients corresponding to each attribute of each product. However, as the model performs iterations, the coefficient values converge.

The example model trainer circuitry 204 divides the set of products with the attributes and corresponding coefficients into a training set and a test set. In some examples, the division of the set of products into a training set and a testing set can correspond to any ratio such as 80:20 or 90:10. Dividing the set of products into two different sets facilitates in determining which attributes for products are significant. When the product importance model is eventually trained, as discussed below, the attributes and associated coefficients corresponding to new (unlabeled) input products of interest allow the model to generate output data regarding whether a product is important or unimportant, determine the likelihood that a product is important or unimportant, and determine the indication of a product's importance. Stated differently, while the model is trained using ground truth data corresponding to a market expert determination of which products are important versus not-important, such market experts may not be available in every geographic region of interest to assess new products. In those circumstances, other market personnel that do not necessarily have expertise in a particular market geographic region of interest may apply their own discretion regarding product importance, which leads to poor market performance. Examples disclosed herein illustrate a technical tool to eliminate and/or otherwise reduce human discretionary input when determining which products are deemed important, thereby facilitating product selection for promotional and/or other advertising purposes (e.g., identifying which particular products to promote). In some examples disclosed herein, products deemed important are identified and such important product details are transmitted to retail personnel with instructions for promotional activity. Stated differently, example technical improvements produce an output that causes any number of real-world results, such as causing a shipment or shipping quantity for a particular product deemed important, or causing a reduction in a shipping quantity for one or more products deemed unimportant.

The example model trainer circuitry 204 generates a first importance probability for each product in the training set. In some examples, the model trainer circuitry 204 generates the importance probability in a manner consistent with example Equation 1.

Importance Probability=f(Σc*a) Equation 1.

In the illustrated example of Equation 1, c represents the coefficient value for each attribute of a product and a represents a frequency of each attribute of the product. A frequency of an attribute is the value corresponding to a number of instances or occurrences of the attribute. For instance, the frequencies of attributes associated with milk may be $125,000 (annual revenue attribute), 0 (number of substitutes attribute), and 50,000 (number of transactions per year attribute). If the associated coefficients for these three attributes were 0.5, 0.3, and 0.1, respectively, the resultant mathematical product of each coefficient value and attribute frequency would be $75,000, 0 substitutes, and 5,000 transactions, respectively. In some examples, the resultant mathematical products of Equation 1 are normalized by the logistic transformation function prior to being summed. The three previously mentioned resultant mathematical products ($75,000, 0 substitutes, and 5,000 transactions) would be normalized by the logistic transformation function to values that add up to a value between 0 and 1. The summation of the resultant mathematical products is known as the first importance probability. As discussed above, the first importance probability is the likelihood that a product is important or not important. Using the previous example above, if the sum of the normalized, resultant mathematical products is 0.9, then this means that there is a 90% chance that this product is important.

After the first importance probability is generated by the example model trainer circuitry 204, a second importance metric is generated. As discussed above, the first importance metric is binary, meaning that it represents a product being important or unimportant (e.g., a value of “1” or “0”, a value of “true” or “false”, etc.). The second importance metric is also binary and initially generated in an arbitrary manner (e.g., randomly) by the example model trainer circuitry 204 when training the product importance model. Eventually in future iterations of implementing the product importance model for new products of interest, as discussed below, third importance metric (corresponding to the testing set) and fourth importance metric (corresponding to a product of interest) would converge to final values (e.g., values that exhibit diminishing returns after further iterations occur, such as values indicative of approaching an asymptote). The second importance metric is arbitrarily generated using the first importance probability generated by the example model trainer circuitry 204. For example, a product (e.g., a first product) in the training set that has a 90% chance of being important may have a second importance metric deemed important. On the other hand, another product (e.g., a second product) in the training set that has a 20% chance of being important may have a second importance metric deemed important as well. However, the latter second importance metric deemed “important” (corresponding to a 20% first importance probability) may not match up or correspond to the first importance metric labeled by the expert (e.g., an expert familiar with a particular geographic region of interest). Thus, an adjustment of the second importance metric and/or the first importance metric of a product in the training set may be required.

To train the product importance model, the example model trainer circuitry 204 compares or matches the second importance metric with the first importance metric for each product in the training set. If the binary values of the first importance metric and the second importance metric do not match, then the example model trainer circuitry 204 adjusts the second importance metric to match the first importance metric. This ensures that the model is being trained for subsequent iterations for new products of interest. If the second importance metric and the first importance metric match, then the example model trainer circuitry 204 proceeds to determine if the first importance probability requires adjustment. For instance, if an expert determines that the first importance probability generated by the example model trainer circuitry 204 is too high or too low, compared to a first threshold value determined by the expert or, in other words, the product is not as important or is much more important, compared to the first threshold value determined by the expert, the example model trainer circuitry 204 adjusts the first importance probability. For example, if the first importance probability and the first importance metric generated by the example model trainer circuitry 204 is 99% and important, respectively, but the first importance probability should be 75% (e.g., a first threshold value determined by the expert), then the example model trainer circuitry 204 adjusts the first importance probability from 99% to 75%. If no adjustment of the first importance probability is required because the first importance probability and the first threshold value match, then the example model trainer circuitry 204 proceeds to determine a second threshold value that differentiates important products in the training set from unimportant products in the training set based on their first importance probability values.

The example model trainer circuitry 204 determines a second threshold value that acts as a dividing point or threshold for distinguishing an important product and an unimportant product in the training set. For example, if there are 24 products in the training set, of which 12 are important products and 12 are unimportant products, and products in the training set with a first importance probability of 60% or higher are considered important by an expert, then the second threshold value is set as 60%. The second threshold value is applied to the product importance model because, as discussed below, the second threshold value will be used to determine a third importance metric for products in the testing set.

After the second threshold value (e.g., an importance probability value) for products in the training set is generated by the example model trainer circuitry 204, a second importance probability for each product in the testing set is generated by the example model trainer circuitry 204. As discussed above, in some examples, the second importance probability is generated by the example model trainer circuitry 204 as a function of coefficient values and attribute frequency (e.g., in a manner consistent with example Equation 1).

Using the second importance probability and second threshold value, the example model trainer circuitry 204 generates a third importance metric for each product in the testing set. A third importance metric is binary and is not arbitrarily generated. For instance, if the second threshold value was 60%, as explained in the previous example, then all products in the testing set with a second importance probability of 60% or higher would have a third importance metric deemed important while all products in the testing set with a second importance probability of less than 60% would have a third importance metric deemed unimportant.

At this point, the example model trainer circuitry 204 evaluates the second probability and third importance metric for each product in the testing set to determine if the product importance model is required to be retrained from the initial phase of identifying a set of products in a geographic region. The example model trainer circuitry 204 evaluates if the product importance model requires retaining by analyzing if the second importance probability matches the first threshold value (e.g., a probability value previously determined by the expert) and the third importance metric matches the first importance metric. In other words, for example, if the second importance probability is too high or too low, compared to a first threshold value determined by the expert, or if the third importance metric should be deemed important instead of unimportant for some products in the testing set or vice versa, then the example model trainer circuitry 204 may determine to retrain the model from the initial phase of identifying a set of products in a geographic region. If the product importance model does not require retraining, then the example model trainer circuitry 204 proceeds to ranking each product in the testing set using the second importance probability.

Ranking the testing set products from a highest to lowest second probability provides a clear view for determining the number of false positives and the number of false negatives. The example model trainer circuitry 204 determines the number of false positives and the number of false negatives to determine whether the product importance model is to be retrained during the post-training phase, as explained below. In other words, the corresponding percentage of false positives and percentage of false negatives will eventually be used as a baseline measure from which the determination of whether to retrain the product importance model can be made. A false positive represents circumstances when a product has an incorrect importance metric or importance probability as compared to an importance metric deemed by an expert. During the training of the product importance model, a false positive is determined by the example model trainer circuitry 204 when the third importance metric is deemed important for a product in the testing set, but the third importance metric should be deemed unimportant for the product in the testing set as compared to the first importance metric for the product in the set of products. Additionally, a false positive is determined by the example model trainer circuitry 204 when there is a second importance probability that is too high, compared to a first threshold value determined by the expert, for a product in the testing set. Conversely, a false negative is determined by the example model trainer circuitry 204 when the third importance metric is deemed unimportant for a product in the testing set, but the third importance metric should be deemed important for the product in the testing set as compared to the first importance metric for the product in the set of products. Additionally, a false negative is determined by the example model trainer circuitry 204 when there is a second importance probability that is too low, compared to a first threshold value determined by the expert, for a product in the testing set.

The example model trainer circuitry 204 determines a percentage of false positives and false negatives for the products in the testing set by comparing the number of false positives and false negatives with the total number of products in the testing set. For instance, if the example model trainer circuitry determines 5 false positives and 3 false negatives out of a total of 30 products in the testing set, then the percentage of false positives and percentage of false negatives is 17% and 10%, respectively. The example model trainer circuitry 204 proceeds to apply the percentage of false positives and percentage of false negatives to the product importance model to be used for later iterations of the product importance model, as explained in more detail below.

After the percentage of false positives and percentage of false negatives is applied to the product importance model, the example model trainer circuitry 204 determines a third threshold value that differentiates the third importance metric. In other words, the third threshold value differentiates products in the testing set deemed important from unimportant, similar to the process of determining a second threshold value for the products in the training set. For example, if there are 20 products in the testing set, of which 10 are deemed important and 10 are deemed unimportant, and the products in the testing set with a second importance probability of 60% or higher are considered important, then the third threshold value is 60%. The third threshold value is applied to the product importance model because, as discussed below, the third threshold value will be used for future iterations.

After the product importance model is trained by the example model trainer circuitry 204, the example product importance model may be invoked to operate in a runtime environment/scenario, in which the example data identifier circuitry 206 identifies a product of interest in a new or existing geographic region. In some examples, multiple products of interest may be identified by the example data identifier circuitry 206. In some examples and as explained above, different geographic regions may consider the same product with varying levels of importance. Similar to the training process executed by the example model trainer circuitry 204, the example data identifier circuitry 206 identifies attributes corresponding to the product of interest.

The example coefficient generator circuitry 208 assigns a coefficient from the logistic regression model to each attribute, identified by the example data identifier circuitry 206. However, instead of arbitrarily assigning coefficient values, the coefficients assigned by the example coefficient generator circuitry 208 uses the coefficient values for attributes from the trained product importance model. In other words, the same coefficient values from the trained importance model are used by the example coefficient generator circuitry 208 in the post-training process. For instance, if the trained product importance model assigned price (an attribute) a 0.5 coefficient value, then price, if identified as an attribute for the product of interest by the example data identifier circuitry 206, will be assigned a coefficient value of 0.5 by the example coefficient generator circuitry 208.

After a coefficient value is assigned to each attribute corresponding to the product of interest, a third importance probability for the product of interest is generated by the example probability generator circuitry 210 using the coefficient value and attribute frequency (in a manner consistent with Equation 1).

The third importance probability along with the third threshold value applied to the product importance model by the example model trainer circuitry 204 are used to determine the fourth importance metric for the product of interest. A fourth importance metric is binary and is not arbitrarily generated. For instance, if the product of interest has a third importance probability of 62% and the third threshold value applied to the product importance model was 60%, then the fourth importance metric, generated by the example metric generator circuitry 212, is deemed important.

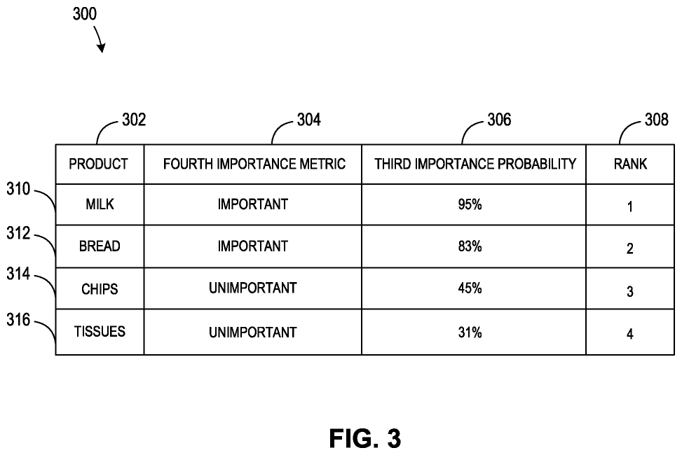

After the fourth importance metric and the third importance probability is generated, the example rank generator circuitry 214 ranks product of interest using the third importance probability. Similar to how the example model trainer circuitry 204 ranked the products in the test set from highest second importance probability to lowest second importance probability, the example rank generator circuitry 214 ranks the product of interest with respect to the set of products in the trained product importance model from highest third importance probability or second importance probability to lowest third importance probability or second importance probability. FIG. 3 illustrates the ranking results by the example rank generator circuitry 214.

FIG. 3 is a table 300 of example ranked products. In the illustrated example of FIG. 3, the table 300 includes an example product column 302, an example fourth importance metric column 304, an example third importance probability column 306, and an example rank column 308. As discussed above, the fourth importance metric is a non-arbitrarily generated, binary metric that represents the product of interest being important or unimportant and is the result of runtime execution of the model. In other words, the table 300 of example ranked products includes beneficial insight for market analysts when attempting to control market decisions that are not wholly based on personnel discretion. Instead, examples disclosed herein reveal and/or otherwise generate actionable information corresponding to voluminous market information that is beyond the capability of human calculation. Additionally, examples disclosed herein illustrate a technological improvement for data analysis that causes strategic decisions to be transmitted to retail organizations on a geographic-by-geographic basis, thereby less influenced by erroneous personnel discretion when local expert resources are unavailable. For instance, examples disclosed herein cause a reduction in shipping of a product (or quantity of products) of interest that is deemed unimportant, thereby improving green energy initiatives that avoid wasteful shipping efforts for products that will not likely sell. The third importance probability is the likelihood that the product of interest is important or not important.

The example product column 302 of FIG. 3 indicates the type of product of interest. The example fourth importance metric column 304 of FIG. 3 indicates whether a product of interest is deemed important or unimportant as determined by the example metric generator circuitry 212. The example third importance probability column 306 of FIG. 3 indicates the likelihood that a product of interest is important as determined by the example probability generator circuitry 210. The example rank column 308 of FIG. 3 indicates the rank of a product of interest using the third importance probability values.

For example, a first row 310 of FIG. 3 illustrates a product of interest, milk, having a fourth importance metric deemed important, a third importance probability of 95%, and a rank of 1. The example first row 310 of FIG. 3 demonstrates that milk is the most important product of interest compared to the other products in the table 300 because it has a rank of 1 due to its relatively highest probability value when compared to other products in the table 300. Conversely, an example fourth row 316 of FIG. 3 illustrates a product of interest, tissues, having a fourth importance metric deemed unimportant, a third importance probability of 31%, and a rank of 4 based on its relative probability value. The example fourth row 316 of FIG. 3 demonstrates that tissues is the least important product of interest compared to the other products in the table 300 because it has a rank of 4.

After the product of interest is ranked by the example rank generator circuitry 214 (as illustrated in FIG. 3), the example indication generator circuitry 216 generates an indication corresponding to the fourth importance metric and the third importance probability for the product of interest. The example indication generator circuitry 216 generates an indication comparing the resultant mathematical products of the coefficient value associated with each attribute and the attribute frequency of the product of interest. The higher the resultant mathematical product of the coefficient value associated with an attribute and the attribute frequency of a product of interest, the more significant it is to the product of interest's fourth importance metric and third importance probability. For example, if a product of interest, chips, had a fourth importance metric deemed unimportant, a third importance probability of 45%, and attributes of price ($4 and coefficient value 0.5) and number of transactions (10 and coefficient value 0.1), then the example indication generator circuitry 216 generates an indication that due to the number of transactions attribute having a resultant mathematical product of 1 between the attribute frequency (10) and the coefficient value (0.1) (meaning least significant attribute compared to the other attribute in this example), chips are unimportant and have a 45% chance of being an important product. In this example, the indication generated by the example indication generator circuitry 216 is: “Indication: Chips are unimportant and have a 45% chance of being an important product due to the number of transactions being insignificant.”. This indication of why a product of interest is important or unimportant and why the likelihood that a product of interest is important or unimportant is that value is based on the attributes and associated coefficient values of the product of interest and the trained product importance model. In some examples, the indication may be a human-readable label, a text value, or a sentence, as shown above.

In some examples, the indication is transmitted to one or more computing systems to cause behaviors that are consistent with the indication. For instance, the indication that “chips” (or a particular brand of chips) are not deemed important in a geographic area of interest is transmitted to retail computing systems to cause particular shelf arrangements to be implemented, such as removing the “chips” product from a promotion shelf of a retail establishment. In some examples, the transmitted indication causes robotic shelf arrangement systems to remove and/or otherwise rearrange the “chips” product so that relatively higher-scoring products can occupy particular shelf space/locations that are at a consumer eye level. In some examples, the transmitted indication causes planogram changes to be implemented at the retail location of interest. In some examples, the indication may cause a dispatch of physical products. In some examples, the indication may cause a response dependent on variances of the third importance probability. For example, if the third importance probability is 61% for a first product of interest and the third importance probability is 78% for a second product of interest, the response for the first product of interest may be to display, in the retail store, a lesser amount of the first product of interest compared to the second product of interest because the second product of interest has a higher third importance probability than the first product of interest.

After the indication for the product of interest is generated, the example model trainer circuitry 204 determines the percentage of false positives and percentage of false negatives. Similar to the determination process explained above during training the product importance model, the example model trainer circuitry 204 determines the percentage of false positives and percentage of false negatives by analyzing whether the product of interest or multiple products of interest have a correct fourth importance metric and a third importance probability based on an expert's opinion.

The example model trainer circuitry 204 then determines if the percentage of false positives and percentage of false negatives for the product of interest or multiple products of interest are greater than the percentage of false positives and percentage of false negatives applied in the product importance model. For instance, if the percentage of false positives and percentage of false negatives applied in the product importance model is 17% and 10%, respectively, and the percentage of false positives and percentage of false negatives for the product of interest or multiple products of interest with respect to the set of products in the trained product importance model are 23% and 15%, then the example model trainer circuitry 204 determines that the product importance model is to be retrained because the new false positive and false negative percentages are higher than the false positive and false negative percentages from trained product importance model. The example model trainer circuitry 204 determines to retrain the product importance model if the new percentage of false positives and new percentage of false negatives are greater than the false positive and false negative percentages applied in the product importance model. If the product importance model does not require retraining, then the example model trainer circuitry continues to identify a new product of interest or multiple new products of interest.

In some examples, the model trainer circuitry 204 apparatus includes means for training the product importance model, the data identifier circuitry 206 includes a means for identifying data, the coefficient generator circuitry 208 includes a means for generating a coefficient, the probability generator circuitry 210 includes a means for generating an importance probability, the metric generator circuitry 212 includes a means for generating an importance metric, the rank generator circuitry 214 includes a means for generating a rank, and the indication generator circuitry 216 includes a means for generating an indication.

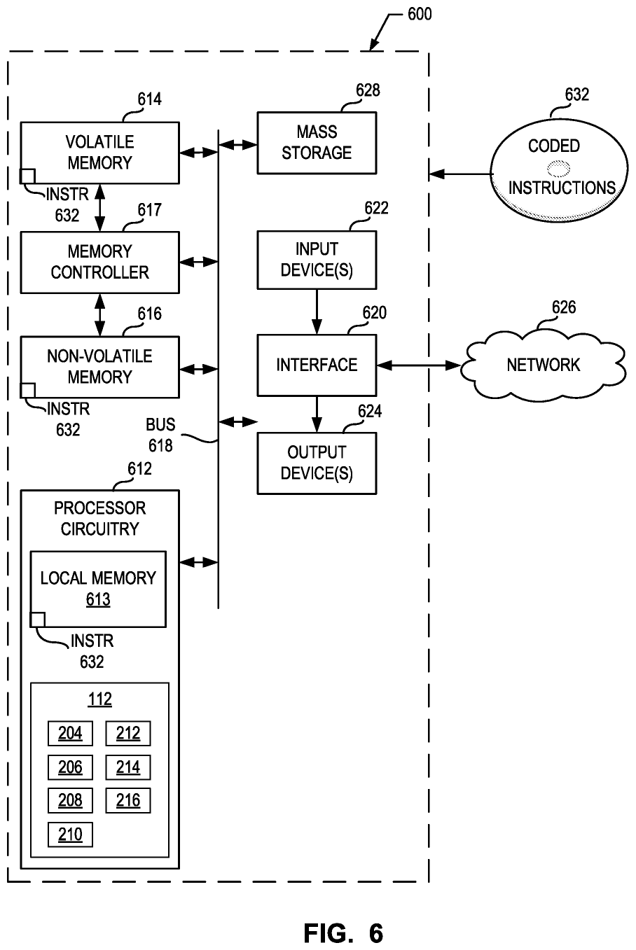

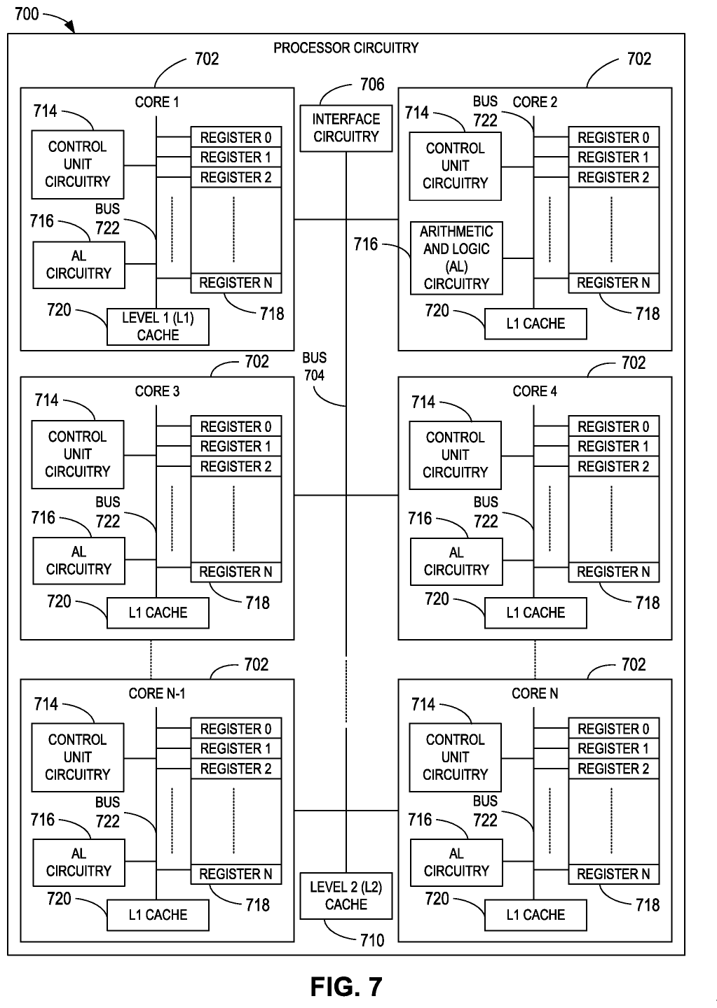

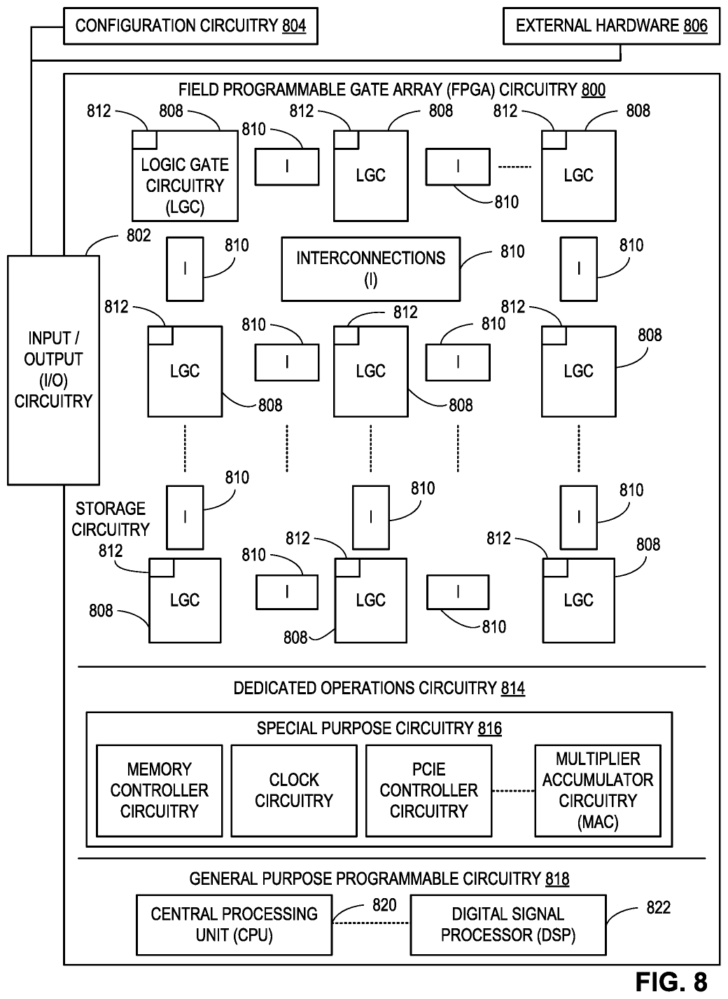

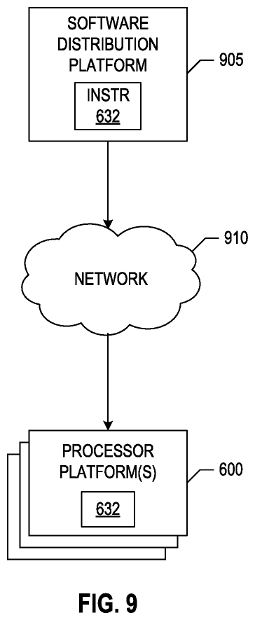

For example, the means for training the product importance model, identifying data, generating a coefficient, generating an importance probability, generating an importance metric, generating a rank, generating an indication may be implemented by example model trainer circuitry 204, example data identifier circuitry 206, example coefficient generator circuitry 208, example probability generator circuitry 210, example metric generator circuitry 212, example rank generator circuitry 214, and example indication generator circuitry 216, respectively. In some examples, the aforementioned circuitry may be instantiated by processor circuitry such as the example processor circuitry 612 of FIG. 6. For instance, the aforementioned circuitry may be instantiated by the example microprocessor 700 of FIG. 7 executing machine executable instructions such as those implemented by at least blocks 902, 904 of FIG. 9. In some examples, the aforementioned circuitry may be instantiated by hardware logic circuitry, which may be implemented by an ASIC, XPU, or the FPGA circuitry 800 of FIG. 8 structured to perform operations corresponding to the machine readable instructions. Additionally or alternatively, the aforementioned circuitry may be instantiated by any other combination of hardware, software, and/or firmware. For example, the aforementioned circuitry may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the example product importance circuitry 112 of FIG. 2 is illustrated in FIGS. 1 and 2, one or more of the elements, processes, and/or devices illustrated in FIGS. 1 and 2 may be combined, divided, re-arranged, omitted, eliminated, and/or implemented in any other way. Further, the example model trainer circuitry 204, the example data identifier circuitry 206, the example coefficient generator circuitry 208, the example probability generator circuitry 210, the example metric generator circuitry 212, the example rank generator circuitry 214, the example indication generator circuitry 216 and/or, more generally, the example product importance circuitry 112 of FIGS. 1 and 2, may be implemented by hardware alone or by hardware in combination with software and/or firmware. Thus, for example, any of the example model trainer circuitry 204, the example data identifier circuitry 206, the example coefficient generator circuitry 208, the example probability generator circuitry 210, the example metric generator circuitry 212, the example rank generator circuitry 214, the example indication generator circuitry 216 and/or, more generally, the example product importance circuitry 112 of FIGS. 1 and 2, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example product importance circuitry 112 of FIGS. 1 and 2 may include one or more elements, processes, and/or devices in addition to, or instead of, those illustrated in FIG. 2, and/or may include more than one of any or all of the illustrated elements, processes and devices.

Flowcharts representative of example machine readable instructions, which may be executed to configure processor circuitry to implement the product importance circuitry 112 of FIGS. 1 and 2, are shown in FIGS. 4 and 5. The machine readable instructions may be one or more executable programs or portion(s) of an executable program for execution by processor circuitry, such as the processor circuitry 612 shown in the example processor platform 600 discussed below in connection with FIG. 6 and/or the example processor circuitry discussed below in connection with FIGS. 7 and/or 8. The program(s) may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 4 and 5, many other methods of implementing the example product importance circuitry 112 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4 and 5 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 4 is a flowchart representative of example machine readable instructions and/or example operations 400 that may be executed and/or instantiated by processor circuitry to determine product importance. The machine readable instructions and/or the operations 400 of FIG. 4 begin at block 402, at which the example model trainer circuitry trains the product importance model. As described in further detail below, FIG. 5 illustrates an example subroutine 402 of the example machine readable instructions and/or the operations 400 of FIG. 4.

Briefly turning to FIG. 5, further details corresponding to block 402 are explained before discussing further aspects of FIG. 4. FIG. 5 is a flowchart representative of additional detail corresponding to training the product importance model (block 402 of FIG. 4). In the illustrated example of FIG. 5, the example model trainer circuitry identifies a set of products (e.g., milk, bread, chips, tissues, etc.) in a first geographic region of interest (block 502). In some examples, set of products includes at least ten important products and at least ten unimportant products, with an equal number of important products and unimportant products (block 502). The consideration of each product in the set of products being important or unimportant is made by an expert, which is an initial discretionary aspect of examples disclosed herein (block 502). As discussed above, the consideration of each product in the set of products being important or unimportant is also known as a first importance metric and the first importance metric is a binary metric that represents each product in the set of products being important or unimportant (block 502).

At block 504, the example model trainer circuitry 204 identifies attributes (e.g., revenue, number of transactions, number of substitutes, price, etc.) for each product in the set of products.

At block 506, the example model trainer circuitry 204 arbitrarily assigns a coefficient from a logistic regression model to each attribute. As discussed above, a coefficient is a value greater than or equal to 0 that is assigned to an attribute (block 506). The higher the resultant mathematical product of an attribute frequency and its coefficient value, the more significant the attribute is (block 506). In some examples, the coefficient is generated from a logistic regression model (block 506).

At block 508, the example model trainer circuitry 204 divides the set of products with the attributes and corresponding coefficients into a training set and a test set. In some examples, the division of the set of products into a training set and a testing set can correspond to any ratio such as 80:20 or 90:10 (block 508). Dividing the set of products into two different sets facilitates in determining which attributes for products are significant (block 508).

At block 510, the example model trainer circuitry 204 generates a first importance probability for each product in the training set using the coefficient and the attribute frequency. In some examples, the model trainer circuitry 204 generates the importance probability in a manner consistent with example Equation 1 (block 510).

At block 512, the example model trainer circuitry 204 generates a second importance metric using the first importance probability. The second importance metric is binary and initially generated in an arbitrary manner (e.g., randomly) by the example model trainer circuitry 204 when training the product importance model (block 512).

At block 514, the example model trainer circuitry 204 determines if the second importance metric matches with the first importance metric for each product in the training set. If the second importance metric matches with the first importance metric for each product in the training set, the process proceeds to block 518 (block 514). If the second importance metric does not match with the first importance metric for each product in the training set, then the process proceeds to block 516 (block 514).

At block 516, the example model trainer circuitry 204 adjusts the second importance metric to match the first importance metric.

At block 518, the example model trainer circuitry 204 determines if the first importance probability requires adjustment by comparing the first importance probability with the first threshold value (e.g., determined by the expert). If the expert determines that the first importance probability generated by is too high or too low, compared to a first threshold value determined by the expert, the example model trainer circuitry 204 proceeds to block 520 (block 518). If the expert determines that the first importance probability generated by is not too high or too low, compared to a first threshold value determined by the expert, the example model trainer circuitry 204 proceeds to block 522 (block 518).

At block 520, the example model trainer circuitry 204 adjusts the first importance probability to match the first threshold for each product in the training set.

At block 522, the example model trainer circuitry 204 determines a second threshold value that differentiates important products in the training set from unimportant products in the training set based on their first importance probability values. The example model trainer circuitry 204 determines a second threshold value that acts as a dividing point or threshold for distinguishing an important product and an unimportant product in the training set (block 522).

At block 524, the example model trainer circuitry 204 applies the second threshold value to the product importance model because the second threshold value will be used to determine the third importance metric for products in the testing set.

At block 526, the example model trainer circuitry 204 generates a second importance probability for each product in the testing set. As discussed above, in some examples, the second importance probability is generated by the example model trainer circuitry 204 in a manner consistent with example Equation 1 (block 526).

At block 528, the example model trainer circuitry 204 generates a third importance metric for each product in the testing set using the second importance probability and second threshold value. A third importance metric is binary and is not arbitrarily generated (block 528).

At block 530, the example model trainer circuitry 204 determines if the product importance model is required to be retrained from the initial phase of identifying a set of products in a geographic region. The example model trainer circuitry 204 evaluates if the product importance model requires retaining by analyzing if the second importance probability relates to the first threshold value determined by the expert and the third importance metric relates to the first importance metric (block 530). If the product importance model requires retraining, the example model trainer circuitry 204 proceeds to block 502 (block 530). If the product importance model does not require retraining, the example model trainer circuitry 204 proceeds to block 532 (block 530).

At block 532, the example model trainer circuitry 204 ranks each product in the testing set using the second importance probability (e.g., ranking from a highest to lowest second probability).

At block 534, the example model trainer circuitry 204 determines the percentage of false positives and percentage of false negatives for the products in the testing set by comparing the number of false positives and false negatives with the total number of products in the testing set.

At block 536, the example model trainer circuitry 204 applies the percentage of false positives and percentage of false negatives to the product importance model to be used for later iterations of the product importance model.

At block 538, the example model trainer circuitry 204 determines the third threshold value that differentiates the third importance metric. In other words, the third threshold value differentiates products in the testing set deemed important from unimportant, similar to the process of determining a second threshold value for the products in the training set (block 538).

At block 540, the example model trainer circuitry 204 applies the third threshold value to the product importance model because the third threshold value will be used for future iterations. Block 540 proceeds to block 404 after the product importance model is trained (block 540).

Returning to the illustrated example of FIG. 4, at block 404, the example data identifier circuitry 206 identifies a product of interest in a new or existing geographic region (block 404). In some examples, multiple products of interest may be identified by the example data identifier circuitry 206 (block 404). In some examples and as explained above, different geographic regions may consider the same product with varying levels of importance (block 404).

At block 406, the example data identifier circuitry 206 identifies attributes (e.g., revenue, number of transactions, number of substitutes, price, etc.) corresponding to the product of interest. As discussed above, an attribute is a transactional characteristic associated with a product (block 406).

At block 408, the example coefficient generator circuitry 208 assigns a coefficient from the logistic regression model to each attribute, identified by the example data identifier circuitry 206. The coefficients assigned by the example coefficient generator circuitry 208 are the coefficient values for attributes from the trained product importance model (block 408). In other words, the same coefficient values from the trained importance model are used by the example coefficient generator circuitry 208 (block 408).

At block 410, the example probability generator circuitry 210 generates the third importance probability for the product of interest using the coefficient value and attribute frequency (in a manner consistent with Equation 1).

At block 412, the example metric generator circuitry 212 generates the fourth importance metric for the product of interest using the third importance probability and the third threshold value applied to the product importance model by the example model trainer circuitry 204. As discussed above, the fourth importance metric is binary and is not arbitrarily generated, unlike during training the product importance model (block 412).

At block 414, the example rank generator circuitry 214 ranks product of interest using the third importance probability. The example rank generator circuitry 214 ranks the product of interest with respect to the set of products in the trained product importance model from highest third importance probability or second importance probability to lowest third importance probability or second importance probability (block 414).

At block 416, the example indication generator circuitry 216 generates an indication corresponding to the fourth importance metric and the third importance probability for the product of interest. The example indication generator circuitry 216 generates an indication comparing the resultant mathematical products of the coefficient values associated with each attribute and attribute frequency of the product of interest (block 416). The higher the resultant mathematical product of the coefficient value associated with an attribute and the attribute frequency of a product of interest, the more significant it is to the products of interest's fourth importance metric and third importance probability (block 416).

At block 418, the example model trainer circuitry 204 determines the percentage of false positives and percentage of false negatives. The example model trainer circuitry 204 determines the percentage of false positives and percentage of false negatives by analyzing whether the product of interest or multiple products of interest have a correct fourth importance metric and a third importance probability based on an expert's opinion (block 418).

At block 420, the example model trainer circuitry 204 determines if the percentage of false positives and percentage of false negatives for the product of interest or multiple products of interest are greater than the percentage of false positives and percentage of false negatives applied in the product importance model. The example model trainer circuitry 204 proceeds to block 422 if the example model trainer circuitry 204 determines that the percentage of false positives and percentage of false negatives for the product of interest or multiple products of interest are greater than the percentage of false positives and percentage of false negatives applied in the product importance model (block 420). If not, the process returns to block 404 (block 420).

At block 422, the example model trainer circuitry 204 determines if the product importance model requires retraining. If the product importance model requires retraining, the process proceeds to block 402 (block 422). If the product importance model does not require retraining, then the process proceeds to block 404 (block 422).

FIG. 6 is a block diagram of an example processor platform 600 structured to execute and/or instantiate the machine readable instructions and/or the operations of FIGS. 4 and 5 to implement the example product importance circuitry 112 of FIGS. 1 and 2. The processor platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 600 of the illustrated example includes processor circuitry 612. The processor circuitry 612 of the illustrated example is hardware. For example, the processor circuitry 612 can be implemented by one or more integrated circuits, logic circuits, FPGAs, microprocessors, CPUs, GPUs, DSPs, and/or microcontrollers from any desired family or manufacturer. The processor circuitry 612 may be implemented by one or more semiconductor based (e.g., silicon based) devices. In this example, the processor circuitry 612 implements the example model trainer circuitry 204, example data identifier circuitry 206, example coefficient generator circuitry 208, example probability generator circuitry 210, example metric generator circuitry 212, example rank generator circuitry 214, example indication generator circuitry 216 and example product importance circuitry 112 as illustrated in FIGS. 1 and 2.

The processor circuitry 612 of the illustrated example includes a local memory 613 (e.g., a cache, registers, etc.). The processor circuitry 612 of the illustrated example is in communication with a main memory including a volatile memory 614 and a non-volatile memory 616 by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617.

The processor platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user to enter data and/or commands into the processor circuitry 612. The input device(s) 622 can be implemented by, for example, an audio sensor, a microphone, a camera (still or video), a keyboard, a button, a mouse, a touchscreen, a track-pad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 600 of the illustrated example also includes one or more mass storage devices 628 to store software and/or data. Examples of such mass storage devices 628 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 632, which may be implemented by the machine readable instructions of FIGS. 4 and 5, may be stored in the mass storage device 628, in the volatile memory 614, in the non-volatile memory 616, and/or on a removable non-transitory computer readable storage medium such as a CD or DVD.

FIG. 7 is a block diagram of an example implementation of the processor circuitry 612 of FIG. 6. In this example, the processor circuitry 612 of FIG. 6 is implemented by a microprocessor 700. For example, the microprocessor 700 may be a general purpose microprocessor (e.g., general purpose microprocessor circuitry). The microprocessor 700 executes some or all of the machine readable instructions of the flowcharts of FIGS. 4 and 5 to effectively instantiate the circuitry of FIG. 2 as logic circuits to perform the operations corresponding to those machine readable instructions. In some such examples, the circuitry of FIG. 2 is instantiated by the hardware circuits of the microprocessor 700 in combination with the instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowcharts of FIGS. 4 and 5.

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I2C) bus, a Serial Peripheral Interface (SPI) bus, a PCI bus, or a PCIe bus. Additionally or alternatively, the first bus 704 may be implemented by any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating point operations. In yet other examples, the AL circuitry 716 may include first AL circuitry that performs integer based operations and second AL circuitry that performs floating point operations. In some examples, the AL circuitry 716 may be referred to as an Arithmetic Logic Unit (ALU). The registers 718 are semiconductor-based structures to store data and/or instructions such as results of one or more of the operations performed by the AL circuitry 716 of the corresponding core 702. For example, the registers 718 may include vector register(s), SIMD register(s), general purpose register(s), flag register(s), segment register(s), machine specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure including distributed throughout the core 702 to shorten access time. The second bus 722 may be implemented by at least one of an I2C bus, a SPI bus, a PCI bus, or a PCIe bus

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 8 is a block diagram of another example implementation of the processor circuitry 612 of FIG. 6. In this example, the processor circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the machine readable instructions in hardware and, thus, can often execute the operations faster than they could be performed by a general purpose microprocessor executing the corresponding software.

More specifically, in contrast to the microprocessor 700 of FIG. 7 described above (which is a general purpose device that may be programmed to execute some or all of the machine readable instructions represented by the flowcharts of FIGS. 4 and 5 but whose interconnections and logic circuitry are fixed once fabricated), the FPGA circuitry 800 of the example of FIG. 8 includes interconnections and logic circuitry that may be configured and/or interconnected in different ways after fabrication to instantiate, for example, some or all of the machine readable instructions represented by the flowcharts of FIGS. 4 and 5. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the software represented by the flowcharts of FIGS. 4 and 5. As such, the FPGA circuitry 800 may be structured to effectively instantiate some or all of the machine readable instructions of the flowcharts of FIGS. 4 and 5 as dedicated logic circuits to perform the operations corresponding to those software instructions in a dedicated manner analogous to an ASIC. Therefore, the FPGA circuitry 800 may perform the operations corresponding to the some or all of the machine readable instructions of FIGS. 4 and 5 faster than the general purpose microprocessor can execute the same.

In the example of FIG. 8, the FPGA circuitry 800 is structured to be programmed (and/or reprogrammed one or more times) by an end user by a hardware description language (HDL) such as Verilog. The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtain machine readable instructions to configure the FPGA circuitry 800, or portion(s) thereof. In some such examples, the configuration circuitry 804 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 806 may be implemented by external hardware circuitry. For example, the external hardware 806 may be implemented by the microprocessor 700 of FIG. 7. The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations that may correspond to at least some of the machine readable instructions of FIGS. 4 and 5 and/or other desired operations. The logic gate circuitry 808 shown in FIG. 8 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example Dedicated Operations Circuitry 814. In this example, the Dedicated Operations Circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the processor circuitry 612 of FIG. 6, many other approaches are contemplated. For example, as mentioned above, modern FPGA circuitry may include an on-board CPU, such as one or more of the example CPU 820 of FIG. 8. Therefore, the processor circuitry 612 of FIG. 6 may additionally be implemented by combining the example microprocessor 700 of FIG. 7 and the example FPGA circuitry 800 of FIG. 8. In some such hybrid examples, a first portion of the machine readable instructions represented by the flowcharts of FIGS. 4 and 5 may be executed by one or more of the cores 702 of FIG. 7, a second portion of the machine readable instructions represented by the flowcharts of FIGS. 4 and 5 may be executed by the FPGA circuitry 800 of FIG. 8, and/or a third portion of the machine readable instructions represented by the flowcharts of FIGS. 4 and 5 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the processor circuitry 612 of FIG. 6, which may be in one or more packages. For example, the XPU may include a CPU in one package, a DSP in another package, a GPU in yet another package, and an FPGA in still yet another package.

A block diagram illustrating an example software distribution platform 905 to distribute software such as the example machine readable instructions 632 of FIG. 6 to hardware devices owned and/or operated by third parties is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions of FIGS. 4 and 5, as described above. The one or more servers of the example software distribution platform 905 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions of FIGS. 4 and 5, may be downloaded to the example processor platform 600, which is to execute the machine readable instructions 632 to implement the example product importance circuitry 112. In some examples, one or more servers of the software distribution platform 905 periodically offer, transmit, and/or force updates to the software (e.g., the example machine readable instructions 632 of FIG. 600) to ensure improvements, patches, updates, etc., are distributed and applied to the software at the end user devices.

From the foregoing, it will be appreciated that example systems, methods, apparatus, and articles of manufacture have been disclosed that determine product important. Disclosed systems, methods, apparatus, and articles of manufacture improve the efficiency of using a computing device by streamlining the product importance determination process. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to determine product importance are disclosed herein. Further examples and combinations thereof include the following:

Example 1 includes an apparatus to determine product importance comprising at least one memory, machine readable instructions, and processor circuitry to at least one of instantiate or execute the machine readable instructions to identify transactional attributes associated with a product of interest, apply a machine learning model to generate a coefficient for respective ones of the transactional attributes associated with the product of interest, generate an importance probability corresponding to the product of interest based on the coefficient for respective ones of the transactional attributes and a frequency of the respective ones of the transactional attributes, generate a binary importance metric based on the importance probability and a threshold value, generate an indication for the importance probability and the binary importance metric of the product of interest based on the coefficient for respective ones of the transactional attributes and the frequency of the respective ones of the transactional attributes, and cause a trigger response based on the indication corresponding to the product of interest.

Example 2 includes the apparatus of example 1, wherein the transactional attributes include at least one of a revenue, a number of transactions, a number of substitute products, or a price associated with the product of interest.

Example 3 includes the apparatus of example 1, wherein the importance probability corresponding to the product of interest is a logistic function of (a) a summation of a mathematical product of the coefficient for respective ones of the transactional attributes and (b) the frequency of the respective ones of the transactional attributes.

Example 4 includes the apparatus of example 1, wherein the binary importance metric represents at least one of an importance product of interest or an unimportant product of interest.

Example 5 includes the apparatus of example 1, wherein the threshold value is applied to the machine learning model.

Example 6 includes the apparatus of example 1, wherein the binary importance metric is generated by comparing the importance probability with the threshold value.

Example 7 includes the apparatus of example 1, wherein the indication represents a reason for the importance probability and the binary importance metric of the product of interest.

Example 8 includes the apparatus of example 1, wherein the trigger response is a dispatch of physical products.

Example 9 includes an apparatus to determine product importance, comprising data identifier circuitry to identify transactional attributes associated with a product of interest, coefficient generator circuitry to apply a machine learning model to generate a coefficient for respective ones of the transactional attributes associated with the product of interest, probability generator circuitry to generate an importance probability corresponding to the product of interest based on the coefficient for respective ones of the transactional attributes and a frequency of the respective ones of the transactional attributes, metric generator circuitry to generate a binary importance metric based on the importance probability and a threshold value, and indication generator circuitry to generate an indication for the importance probability and the binary importance metric of the product of interest based on the coefficient for respective ones of the transactional attributes and the frequency of the respective ones of the transactional attributes, and cause a trigger response based on the indication corresponding to the product of interest.

Example 10 includes the apparatus of example 9, wherein the transactional attributes include at least one of a revenue, a number of transactions, a number of substitute products, or a price associated with the product of interest.

Example 11 includes the apparatus of example 9, wherein the importance probability corresponding to the product of interest is a logistic function of (a) a summation of a mathematical product of the coefficient for respective ones of the transactional attributes and (b) the frequency of the respective ones of the transactional attributes.

Example 12 includes the apparatus of example 9, wherein the binary importance metric represents at least one of an importance product of interest or an unimportant product of interest.

Example 13 includes the apparatus of example 9, wherein the threshold value is applied to the machine learning model.

Example 14 includes the apparatus of example 9, wherein the binary importance metric is generated by comparing the importance probability with the threshold value.

Example 15 includes the apparatus of example 9, wherein the indication represents a reason for the importance probability and the binary importance metric of the product of interest.

Example 16 includes the apparatus of example 9, wherein the trigger response is a dispatch of physical products.

Example 17 includes a non-transitory machine readable storage medium comprising instructions that, when executed, cause processor circuitry to at least identify transactional attributes associated with a product of interest, apply a machine learning model to generate a coefficient for respective ones of the transactional attributes associated with the product of interest, generate an importance probability corresponding to the product of interest based on the coefficient for respective ones of the transactional attributes and a frequency of the respective ones of the transactional attributes, generate a binary importance metric based on the importance probability and a threshold value, generate an indication for the importance probability and the binary importance metric of the product of interest based on the coefficient for respective ones of the transactional attributes and the frequency of the respective ones of the transactional attributes, and cause a trigger response based on the indication corresponding to the product of interest.

Example 18 includes the non-transitory machine readable storage medium of example 17, wherein the transactional attributes include at least one of a revenue, a number of transactions, a number of substitute products, or a price associated with the product of interest.

Example 19 includes the non-transitory machine readable storage medium of example 17, wherein the importance probability corresponding to the product of interest is a logistic function of (a) a summation of a mathematical product of the coefficient for respective ones of the transactional attributes and (b) the frequency of the respective ones of the transactional attributes.

Example 20 includes the non-transitory machine readable storage medium of example 17, wherein the binary importance metric represents at least one of an importance product of interest or an unimportant product of interest.

Example 21 includes the non-transitory machine readable storage medium of example 17, wherein the threshold value is applied to the machine learning model.

Example 22 includes the non-transitory machine readable storage medium of example 17, wherein the binary importance metric is generated by comparing the importance probability with the threshold value.

Example 23 includes the non-transitory machine readable storage medium of example 17, wherein the indication represents a reason for the importance probability and the binary importance metric of the product of interest.

Example 24 includes the non-transitory machine readable storage medium of example 17, wherein the trigger response is a dispatch of physical products.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus to determine product importance comprising:
at least one memory;
machine readable instructions; and
processor circuitry to at least one of instantiate or execute the machine readable instructions to:
identify transactional attributes associated with a product of interest;
apply a machine learning model to generate a coefficient for respective ones of the transactional attributes associated with the product of interest;
generate an importance probability corresponding to the product of interest based on the coefficient for respective ones of the transactional attributes and a frequency of the respective ones of the transactional attributes;
generate a binary importance metric based on the importance probability and a threshold value;
generate an indication for the importance probability and the binary importance metric of the product of interest based on the coefficient for respective ones of the transactional attributes and the frequency of the respective ones of the transactional attributes; and
cause a trigger response based on the indication corresponding to the product of interest.

2. The apparatus of claim 1, wherein the transactional attributes include at least one of a revenue, a number of transactions, a number of substitute products, or a price associated with the product of interest.

3. The apparatus of claim 1, wherein the importance probability corresponding to the product of interest is a logistic function of (a) a summation of a mathematical product of the coefficient for respective ones of the transactional attributes and (b) the frequency of the respective ones of the transactional attributes.

4. The apparatus of claim 1, wherein the binary importance metric represents at least one of an importance product of interest or an unimportant product of interest.

5. (canceled)

6. The apparatus of claim 1, wherein the binary importance metric is generated by comparing the importance probability with the threshold value.

7. The apparatus of claim 1, wherein the indication represents a reason for the importance probability and the binary importance metric of the product of interest.

8. The apparatus of claim 1, wherein the trigger response is a dispatch of physical products.

9. An apparatus to determine product importance, comprising:
data identifier circuitry to identify transactional attributes associated with a product of interest;
coefficient generator circuitry to apply a machine learning model to generate a coefficient for respective ones of the transactional attributes associated with the product of interest;
probability generator circuitry to generate an importance probability corresponding to the product of interest based on the coefficient for respective ones of the transactional attributes and a frequency of the respective ones of the transactional attributes;
metric generator circuitry to generate a binary importance metric based on the importance probability and a threshold value; and
indication generator circuitry to:
generate an indication for the importance probability and the binary importance metric of the product of interest based on the coefficient for respective ones of the transactional attributes and the frequency of the respective ones of the transactional attributes; and
cause a trigger response based on the indication corresponding to the product of interest.

10. The apparatus of claim 9, wherein the transactional attributes include at least one of a revenue, a number of transactions, a number of substitute products, or a price associated with the product of interest.

11. The apparatus of claim 9, wherein the importance probability corresponding to the product of interest is a logistic function of (a) a summation of a mathematical product of the coefficient for respective ones of the transactional attributes and (b) the frequency of the respective ones of the transactional attributes.

12. The apparatus of claim 9, wherein the binary importance metric represents at least one of an importance product of interest or an unimportant product of interest.

13. The apparatus of claim 9, wherein the threshold value is applied to the machine learning model.

14. (canceled)

15. The apparatus of claim 9, wherein the indication represents a reason for the importance probability and the binary importance metric of the product of interest.

16. The apparatus of claim 9, wherein the trigger response is a dispatch of physical products.

17. A non-transitory machine readable storage medium comprising instructions that, when executed, cause processor circuitry to at least:
identify transactional attributes associated with a product of interest;
apply a machine learning model to generate a coefficient for respective ones of the transactional attributes associated with the product of interest;
generate an importance probability corresponding to the product of interest based on the coefficient for respective ones of the transactional attributes and a frequency of the respective ones of the transactional attributes;
generate a binary importance metric based on the importance probability and a threshold value;
generate an indication for the importance probability and the binary importance metric of the product of interest based on the coefficient for respective ones of the transactional attributes and the frequency of the respective ones of the transactional attributes; and
cause a trigger response based on the indication corresponding to the product of interest.

18. The non-transitory machine readable storage medium of claim 17, wherein the transactional attributes include at least one of a revenue, a number of transactions, a number of substitute products, or a price associated with the product of interest.

19. The non-transitory machine readable storage medium of claim 17, wherein the importance probability corresponding to the product of interest is a logistic function of (a) a summation of a mathematical product of the coefficient for respective ones of the transactional attributes and (b) the frequency of the respective ones of the transactional attributes.

20. The non-transitory machine readable storage medium of claim 17, wherein the binary importance metric represents at least one of an importance product of interest or an unimportant product of interest.

21. The non-transitory machine readable storage medium of claim 17, wherein the threshold value is applied to the machine learning model.

22. The non-transitory machine readable storage medium of claim 17, wherein the binary importance metric is generated by comparing the importance probability with the threshold value.

23. (canceled)

24. (canceled)
